(19) United States
(12) Patent Application Publication
(10) Pub. No.: US 2022/0056273 A1
(43) Pub. Date: Feb. 24, 2022

(54) COATING COMPRISING PETROLEUM COKE

(71) Applicant: TOTAL MARKETING SERVICES, Puteaux (FR)

(72) Inventors: Romain COLLIAT, Ruy-Montceau (FR); Laurence LAPALU, Villeurbanne (FR)

(21) Appl. No.: 17/415,317

(22) PCT Filed: Dec. 17, 2019
(86) PCT No.: PCT/FR2019/053133

§ 371 Date: Jun. 17, 2021

(30) Foreign Application Priority Data
Dec. 18, 2018 (FR) 1873124

(51) Int. Cl. C08L 95/00; C08K 3/04

(52) U.S. Cl. CPC C08L 95/00; C08K 2201/005; C08L 2555/52; C08K 3/04

(57) ABSTRACT

A bituminous mix has aggregates, petroleum coke, and at least one hydrocarbon binder. The bituminous mix has at least 50% by weight of aggregates and at least 8% by weight of petroleum coke. The bituminous mix is prepared by mixing the aggregates, petroleum coke, and the at least one hydrocarbon binder at a mixing temperature ranging from 100 to 220° C.

### FIELD OF THE INVENTION

The present invention concerns bituminous mixes having a high content of petroleum coke, methods for preparing such bituminous mixes and use thereof as road construction courses or ground surfacing material, or in various industrial applications in particular for preparing a waterproof coating, a membrane or priming layer.

### TECHNICAL BACKGROUND

Petroleum coke (or “petcoke”) is a by-product derived from the refining of petroleum. Different applications have been developed to recycle this product. At the current time it is often used as fuel or for the production of electrodes. The use of petroleum coke has also been contemplated in roadway applications.

For example, documents FR 1591491 and U.S. Pat. No. 3,802,898 describe hydrocarbon bituminous mixes that can comprise a small proportion of petroleum coke as a filler.

Documents U.S. Pat. Nos. 4,028,293 and 4,000,095 relate to materials comprising a mineral component, a polymeric component and a hydrocarbon component such as, for example, bitumen, tar or petroleum coke.

Document IN 2704/DEL/2008 describes bitumen with added recycled rubber and petroleum coke.

Documents FR 0817510 and GB 0475387 describe bituminous emulsions that can comprise petroleum coke as a mineral colouring filler.

There is a true need to provide a bituminous mix intended for the road industry having good thermal and sound insulation properties, which is also recyclable and economic and able to act as a carbon sink.

### SUMMARY OF THE INVENTION

The invention first relates to a bituminous mix comprising at least 50% by weight of aggregates, at least 8% by weight of petroleum coke and at least one hydrocarbon binder.

In some embodiments, the weight ratio of the petroleum coke to the hydrocarbon binder is 1.8 or higher, preferably 2 or higher.

In some embodiments, the bituminous mix comprises from 8 to 45% by weight, preferably 10 to 30% by weight, of petroleum coke.

In some embodiments, the petroleum coke has a maximum particle size of 20 mm or less, preferably 5 mm or less.

In some embodiments, the petroleum coke has a maximum particle size of less than 63 μm.

In some embodiments, the aggregates are selected from the group consisting of coarse aggregates having a particle size of 6.3 mm or greater, medium aggregates having a particle size greater than 2 mm and less than 6.3 mm, fine aggregates having a particle size of 63 μm to 2 mm, fines having a particle size of less than 63 μm, and combinations thereof.

In some embodiments, the bituminous mix comprises from 50 to 90% by weight, preferably 60 to 85% by weight of aggregates.

In some embodiments, the bituminous mix comprises as aggregates:
from 0 to 90% by weight, preferably 5 to 65% by weight, of coarse aggregates having a particle size of 6.3 mm or greater;
from 0 to 90% by weight, preferably 5 to 65% by weight, of medium aggregates having a particle size greater than 2 mm and less than 6.3 mm;
from 0 to 70 by weight, preferably 5 to 65, by weight of fine aggregates having a particle size of 63 μm to 2 mm; and
from 0 to 40% by weight, preferably 0 to 20% by weight, of fines having a particle size of less than 63 μm;
   relative to the total weight of the bituminous mix.

In some embodiments, the bituminous mix comprises from 2 to 20% by weight, preferably 5 to 15% by weight of hydrocarbon binder.

In some embodiments, the hydrocarbon binder is selected from the group consisting of bitumens, pitch, light-coloured binders and mixtures thereof.

In some embodiments, the bituminous mix further comprises from 0 to 20% by weight of additives, preferably selected from the group consisting of colouring agents, anti-caking compounds, emulsifying agents, reinforcing fibres such as cellulose fibres, glass fibres, metal fibres, anti-stripping agents, additives for lowering temperatures of production, application and/or compacting of the bituminous mix, and mixtures thereof.

In some embodiments, the bituminous mix comprises:
from 8 to 45% by weight, preferably 10 to 30% by weight, of petroleum coke;
from 10 to 65% by weight, preferably 15 to 50% by weight, of coarse aggregates having a particle size of 6.3 mm or greater;
from 10 to 65% by weight, preferably 12 to 40% by weight, of medium aggregates having a particle size greater than 2 mm and less than 6.3 mm;
from 5 to 65% by weight, preferably 10 to 50% by weight, of fine aggregates having a particle size of 63 μm to 2 mm;
from 0 to 10% by weight, preferably 0 to 5% by weight, of fines having a particle size of less than 63 μm;
from 2 to 20% by weight, preferably 2 to 10% by weight, of hydrocarbon binder; and
from 0 to 20% by weight of additives.

In some embodiments, the bituminous mix comprises:
from 8 to 40% by weight, preferably 10 to 30% by weight, of petroleum coke;
from 5 to 55% by weight, preferably 10 to 40% by weight, of coarse aggregates having a particle size of 6.3 mm or greater;
from 5 to 55% weight %, preferably 10 to 40% by weight, of medium aggregates having a particle size greater than 2 mm and less than 6.3 mm;
from 5 to 50% by weight, preferably 10 to 40% by weight, of fine aggregates having a particle size of 63 μm to 2 mm;
from 5 to 40% by weight, preferably 8 to 35% by weight, of fines having a particle size of less than 63 μm;
from 2 to 20% by weight, preferably 5 to 15% by weight of hydrocarbon binder; and
from 0 to 20% by weight of additives.

The invention also relates to a method for preparing a bituminous mix as described above, comprising the mixing, at a temperature ranging from 100 to 220° C., of the petroleum coke, aggregates and hydrocarbon binder.

In some embodiments, the mixing temperature is supplied by heating the aggregates and/or petroleum coke to a temperature of 100 to 220° C. before they are mixed with the hydrocarbon binder.

The invention also relates to the use of a bituminous mix as described above in the road industry for forming base courses, binder courses and/or sub-base layers for roadways, or for ground surfacing.

The present invention allows the above need to be met. More particularly, it provides a bituminous mix having good thermal and sound insulation properties. Good thermal insultation for a bituminous mix used for roadway construction or ground surfacing is of particular advantage during periods of strong heat. Indeed, such a bituminous mix having good thermal insultation absorbs less heat and therefore releases less heat in return.

In addition, the bituminous mix of the invention is economic and recyclable, and can form a major carbon sink by durably absorbing a large amount of carbon.

This is achieved through the use in the bituminous mix of petroleum coke in suitable amount.

### BRIEF DESCRIPTION OF THE FIGURES

FIG. 1 shows the cooling kinetics of compositions as described in the example. The temperature (in ° C.) is given along the Y-axis and the time (in min) along the X-axis. Curve A (black) represents the cooling kinetics of composition 1 (comprising petroleum coke) and curve B (grey) represents the cooling kinetics of the reference composition.

FIG. 2 shows the heating kinetics of compositions as described in the example. The temperature (in ° C.) is given along the Y-axis and the time (in min) along the X-axis. Curve A (black) represents the heating kinetics of composition 1 (comprising petroleum coke) and curve B (grey) represents the heating kinetics of the reference composition.

### DETAILED DESCRIPTION

The invention will now be described in more detail without limitation in the following description.

Unless otherwise stated, all percentages concerning quantities are weight percentages.

In the present invention the expression “a hydrocarbon binder” is to be understood as meaning “one or more hydrocarbon binders”. The same applies to all the other components.

### Bituminous Mix

In a first aspect, the invention relates to a bituminous mix. By “bituminous mix” it is meant any mix of a hydrocarbon binder composition with aggregates. Bituminous mixes are used inter alia for the construction and maintenance of road structure and of surface thereof, and for carrying all road works. This designation particularly encompasses bituminous mixes comprising voids and mastic asphalts in which the voids are minimised. More particularly, as bituminous mix, mention can be made of surface dressings, hot mixes, cold mixes, cold-poured mixes, gravel-emulsions, base courses, binder courses, tack coats and surface courses, rut resistant courses, porous mixes or asphalts.

### Petroleum Coke

The bituminous mix of the invention comprises at least 8% by weight of petroleum coke relative to the total weight of the bituminous mix.

Petroleum coke is a carbon solid derived from the refining of petroleum and produced by a coking process from very heavy petroleum fractions. It can be obtained for example by a process coking in a fluidised bed (“fluid coking”) or discontinuous coking (“delayed coking”).

Petroleum coke is the end product of petroleum refining i.e. the product having the highest carbon/hydrogen atomic ratio, typically higher than 25, and therefore having non-measurable viscosity since petroleum coke is in solid form.

Petroleum coke directly output from coking units is called “green coke”. This green coke can undergo a calcination process e.g. in a rotary kiln to remove residual volatile hydrocarbons from the coke: the coke is then known as “calcined coke”.

In the present invention, the petroleum coke can be green petroleum coke or calcined petroleum coke. The petroleum coke is preferably green petroleum coke since it has the advantage of being more economical.

Preferably the maximum particle size of the petroleum coke is 20 mm or less, more preferably 5 mm or less, even more preferably 3 mm or less. In some embodiments, the petroleum coke has a particle size of less than 63 μm. The particle size of petroleum coke can be measured by sieving, for example in accordance with standard NF EN 933-1.

The bituminous mix preferably comprises from 8 to 45% by weight, more preferably from 10 to 30% by weight, of petroleum coke relative to the total weight of the bituminous mix. In some embodiments, the bituminous mix may comprise from 8 to 10% by weight, or 10 to 15% by weight, or 15 to 20% by weight, or 20 to 25% by weight, or 25 to 30% by weight, or 30 to 35% by weight, or 35 to 40% by weight, or 40 to 45% by weight, of petroleum coke relative to the total weight of the bituminous mix.

### Aggregates

Th bituminous mix of the invention comprises at least of 50% by weight of aggregates.

By “aggregate” it is meant any solid fragment having a maximum size of less than 200 mm (such as measured by sieving in accordance with standard NF EN 933-1 for example). In the present invention, this term excludes the particles of petroleum coke.

The aggregates of the invention are mineral and/or synthetic aggregates. These aggregates are preferably derived from the crushing of solid rocks or alluvial rocks. Aggregates therefore refer to a granular material used in building and road industries. An aggregate can be natural, artificial or recycled. The term “natural aggregate” refers to an aggregate that has not undergone any deformation other than mechanical. The term “artificial aggregate” refers to an aggregate of mineral origin resulting from an industrial process comprising heat or other transformation. The term “recycled aggregate” refers to an aggregate previously used for building or other purposes.

Advantageously, the bituminous mix, relative to the total weight thereof, comprises from 50 to 90% by weight of aggregates and more preferably from 60 to 80% by weight, for example from 50 to 55% by weight, or 55 to 60% by weight, or 60 to 65% by weight, or 65 to 70% by weight, or 70 to 75% by weight, or 75 to 80% by weight, or 80 to 85% by weight, or 85 to 90% by weight.

The aggregates are advantageously selected from the group consisting of:
coarse aggregates having a particle size of 6.3 mm or greater, preferably less than 5 cm;
medium aggregates having a particle size greater than 2 mm and less than 6.3 mm;
fine aggregates having a particle size of 63 μm to 2 mm;
fines (or fillers) having a particle size of less than 63 μm; and
combinations thereof.

The particle size (or diameter) of the aggregates can be measured by sieving, for example in accordance with standard NF EN 933-1 or by laser granulometry.

The bituminous mix can comprise from 0 to 90% by weight of coarse aggregates, preferably from 5 to 65% by weight, relative to the total weight of the bituminous mix. In some embodiments, the bituminous mix may comprise from 0 to 10% by weight, or 10 to 20% by weight, or 20 to 30% by weight, or 30 to 40% by weight, or 40 to 50% by weight, or 50 to 60% by weight, or 60 to 70% by weight, or 70 to 80% by weight, or 80 to 90% by weight, of coarse aggregates relative to the total weight of the bituminous mix.

The bituminous mix may also comprise from 0 to 90% by weight of medium aggregates, preferably from 5 to 65%, relative to the total weight of the bituminous mix. In some embodiments, the bituminous mix may comprise from 0 to 10% by weight, or 10 to 20% by weight, or 20 to 30% by weight, or 30 to 40% by weight, or 40 to 50% by weight, or 50 to 60% by weight, or 60 to 70% by weight, or 70 to 80% by weight, or 80 to 90% by weight of medium aggregates relative to the total weight of the bituminous mix.

The bituminous mix may also comprise from 0 to 70% by weight of fine aggregates, preferably from 5 to 65%, relative to the total weight of the bituminous mix. In some embodiments the bituminous mix may comprise from 0 to 5% by weight, or 5 to 10% by weight, or 10 to 15% by weight, or 15 to 20% by weight, or 20 to 25% by weight, or 25 to 30% by weight, or 30 to 35% by weight, or 35 to 40% by weight, or 40 to 45% by weight, or 45 to 50% by weight, or 50 to 55% by weight, or 55 to 60% by weight, or 60 to 65% by weight, or 65 to 70% by weight, of fine aggregates relative to the total weight of the bituminous mix.

The bituminous mix may also comprise from 0 to 40% by weight, preferably from 0 to 20% by weight, of fines, relative to the total weight of the bituminous mix. In some embodiments, the bituminous mix may comprise from 0 to 2% by weight, or 2 to 4% by weight, or 4 to 6% by weight, or 6 to 8% by weight or 8 to 10% by weight, or 10 to 15% by weight, or 15 to 20% by weight, or 20 to 25% by weight, or 25 to 30% by weight, or 35 to 40% by weight, of fines relative to the total weight of the bituminous mix.

The aggregates belonging to the above-described categories (coarse aggregates, medium aggregates fine aggregates and fines), from one category to another, can be of same type or of different type. Similarly, the aggregates in each of the above-described categories can all be of same type or of different type.

The aggregates, irrespective of the category to which they belong, may for example comprise or be composed of limestone, silica and/or magmatic or plutonic rock

The aggregates, in full or in part, can be fragments of bituminous mix derived from the road industry and/or fragments of crushed building material derived from the construction industry, for example milling residues from the recycling of bituminous mixes, gravel and road asphalts with the exception of those containing asbestos fibres. Such fragments may comprise a certain proportion of hydrocarbon binder. In this case, the hydrocarbon binder under consideration is counted together with the separately provided hydrocarbon binder for the needs of calculating the proportions of the different compounds of the bituminous mix. The fragments of bituminous mix derived from the road industry and/or the fragments of crushed building material derived from the construction industry can be present for example in a proportion of 0 to 10% by weight, or from 10 to 20% by weight, or 20 to 30% by weight, or 30 to 40% by weight, or 40 to 50% by weight, or 50 to 60% by weight, or 60 to 70% by weight, or 70 to 80% by weight, or 80 to 90% by weight, relative to the total weight of the bituminous mix. Preferred ranges are from 5 to 70%, or from 15 to 50%, by weight, relative to the total weight of the bituminous mix. The aggregates, in full or in part, can also be fragments of plastic waste, which allows the recycling of such waste.

In particular the fine aggregates can be sand.

### Hydrocarbon Binder

The bituminous mix comprises a hydrocarbon binder. By “binder” it is meant a product allowing the agglomeration of all or part of the solid elements constituting the bituminous mix. By “hydrocarbon binder” it is meant any binder comprising one or more hydrocarbons. In the present invention, this term excludes petroleum coke.

Preferably, the bituminous mix comprises from 2 to 20% by weight of binder, preferably from 5 to 15% by weight, relative to the total weight of the bituminous mix. In some embodiments, the bituminous mix may comprise from 0.1 to 2% by weight, or 2 to 4% by weight, or 4 to 6% by weight, or 6 to 8% by weight, or 8 to 10% by weight, or 10 to 12% by weight, or 12 to 15% by weight, or 15 to 20% by weight, of binder, relative to the total weight of the bituminous mix.

The above-indicated binder quantities refer to the quantity of binder as such and do not take into account any possible additives incorporated in the binder e.g. to facilitate addition thereof to the other constituents of the bituminous mix, for example water when the hydrocarbon binder is added in the form of an emulsion to the mixture for preparing the bituminous mix.

The hydrocarbon binder (as such) preferably has kinematic viscosity at 50° C. of 50 mm²/s or higher, more preferably of 100 mm²/s or higher, for example from 50 to 100 mm²/s, or from 100 to 500 mm²/s, or from 500 to 1000 mm²/s, or from 1000 to 1500 mm²/s, or from 1500 to 2000 mm²/s, or from 2000 to 2500 mm²/s, or from 2500 to 3000 mm²/s, or from 3000 to 3500 mm²/s, or from 3500 to 4000 mm²/s. Kinematic viscosity can be measured at 50° C. in accordance with standard NF EN ISO 3104.

The hydrocarbon binder is advantageously selected from the group consisting of bitumen, pitch, light-coloured binders or mixtures thereof.

The bitumen of the invention preferably has a penetrability of less than 800 tenths of a mm at 25° C. measured in accordance with standard NF EN 1426. In some embodiments, the bitumen has a penetrability at 25° C. measured with standard NF EN 1426 ranging from 10 to 30 tenths of a mm, or from 30 to 50 tenths of a mm, or from 50 to 100 tenths of a mm, or from 100 to 200 tenths of a mm, or from 200 to 300 tenths of a mm, or from 300 to 400 tenths of a mm, or from 400 to 500 tenths of a mm, or from 500 to 600 tenths of a mm, or from 600 to 700 tenths of a mm, or from 700 to 800 tenths of a mm.

The bitumens of the invention can be pure bitumen, modified bitumen or special bitumen, alone or in a mixture. They comprise bitumen of natural origin, those contained in deposits of natural bitumen, of natural asphalt or bituminous sands. The bitumens of the invention also comprise bitumens derived from the refining of crude oil. The bitumens are derived from atmospheric and/vacuum distillation of petroleum. These bitumens may possibly be blown, visbroken and/or derived from the deasphalting process. The different bitumens obtained with refining processes can be combined together. The bitumen can also be a recycled bitumen. The bitumens can be hard grade or soft grade bitumens.

The pitch is also derived from atmospheric and/or vacuum distillation of petroleum. It is essentially used as fuel. Pitch has a viscosity of up to 4000 mm²/s for kinematic viscosity at 50° C. (measured for example according to standard NF EN ISO 3104). Pitch is also known under the term “high viscosity fuel”. The pitch of the invention can be blown pitch also known as oxidized pitch. Oxidized pitch can be obtained by oxidizing a mixture of pitch and a diluent such as a light gasoline, also known as “flux”, that is subjected to an oxidizing operation in a blowing tower in the presence of a catalyst at a set temperature and given pressure.

The pitch preferably has a penetrability at 25° C. of 0 to 20 tenths of a mm, preferably 5 to 20 tenths of a mm, the penetrability being measured in accordance with standard EM 1426. Advantageously, the pitch has a softening point of between 115° C. and 175° C., for example a softening point of between 115° C. and 125° C., between 135 and 145° C. or between 165 and 175° C.

The light-coloured binder of the invention preferably comprises:
a plasticizing agent e.g. a natural or synthetic oil free of asphaltenes, preferably in an amount of 40 to 80% by weight relative to the total weight of the light-coloured binder;
a structuring agent e.g. a hydrocarbon or vegetable resin, preferably in an amount of 20 to 50% by weight, relative to the total weight of the light-coloured binder;
a polymer, advantageously a copolymer, for example a copolymer of styrene and butadiene, preferably in an amount of 1 to 7% by weight relative to the total weight of the light-coloured binder; and
optionally, doping agents, or bonding agents, or anti-stripping agents preferably in an amount of 0.05 to 0.5% by weight relative to the total weight of the light-coloured binder.

Advantageously, the light-coloured binder has a colour value of 4 or less, preferably 3 or less, such as determined by the ASTM DH4 scale. Preferably, it has a Ring-Ball softening temperature determined in accordance with standard NF EN 1427 of between 55° C. and 90° C. The light-coloured binder preferably has a penetrability at 25° C., measured in accordance with standard NF EN1426, of between 10 and 220 tenths of a mm, more preferably between 30 and 100 tenths of a mm, further preferably between 40 and 80 tenths of a mm. The penetrability of the light-coloured binder can be modulated, in particular through a judicious choice of the weight ratio of [structuring agent/plasticizing agent] in the composition of the light-coloured binder. An increase in this ratio will allow a reduction in penetrability at 25° C.

For example, the light-coloured binder can be prepared with a method comprising the steps of:
(i) mixing the plasticizing agent e.g. a paraffinic oil derived from deasphalted fractions of distillation under reduced pressure (vacuum residue VR) of crude oil (DAO oil), or an aromatic oil, and heating to a temperature of between 140 and 200° C., for example for 10 minutes to 30 minutes;
(ii) adding the structuring agent e.g. a hydrocarbon resin, mixing and heating to a temperature of between 140 and 200° C., for example for 30 minutes to 2 hours;
(iii) adding the polymer(s) e.g. a styrene-butadiene-styrene copolymer (SBS), mixing and heating to a temperature of between 140 and 200° C., for example for 90 minutes to 3 hours, preferably from 90 minutes to 2 hours 30;
(iv) optionally adding an anti-stripping agent, mixing, and heating to a temperature of between 140 and 200° C., for example for 5 minutes to 20 minutes.

The order of steps i) to (iv) can be modified.

### Additives

The bituminous mix of the invention may comprise additives. Preferably, these additives are selected from the group consisting of colouring agents, anti-caking compounds, emulsifying agents, reinforcing fibres, anti-stripping agents, additives for lowering temperatures of production, application and/or compacting of the bituminous mix, and mixtures thereof.

Preferably, these additives are present in the bituminous mix in an amount of 0 to 20% by weight, more preferably of 0 to 10% by weight, relative to the total weight of the bituminous mix. In some embodiments, the bituminous mix comprises from 0 to 5% by weight, or 5 to 10% by weight, or 10 to 15% by weight, or 15 to 20% by weight, of additives, relative to the total weight of the bituminous mix.

The colouring agents are intended to colour the bituminous mix, in particular bituminous mix free of bituminous compounds or free of pitch (for example comprising a light-coloured binder as hydrocarbon binder). For example, these may be mineral pigments or organic colouring agents. The pigments are selected in accordance with the desired shade, colour of the bituminous mix. For example, use is made of metal oxides such as iron oxides, chromium oxides, cobalt oxides, titanium oxides to obtain colours of red, yellow, grey, green blue or white.

The anti-caking compounds can be of mineral or organic origin. Mention can be made of talc; cement; carbon; wood residues such as lignin, lignosulfonate, conifer needle powders, conifer cone powders, in particular of pine; glass powder; clays such as kaolin, bentonite, vermiculite; alumina such as alumina hydrates; silica; silica derivatives such as silicates, silicon hydroxides and silicon oxides; powdered plastic materials; lime; gypsum; rubber powder; powder of polymers such as styrene-butadiene copolymers (SB), styrene-butadiene-styrene copolymers (SBS); and mixtures thereof.

The reinforcing fibres can be of any type. Mention can be made for example of cellulose fibres, glass fibres, metal fibres, and mixtures thereof.

To improve mutual affinity between the hydrocarbon binder and the aggregates, and to ensure the durability thereof, the bituminous mix of the invention may also comprise anti-stripping agents as additive. For example, these are nitrogen-containing surfactant compounds derived from fatty acids (amines, polyamines, alkyl-polyamines, etc.). When added to the bituminous mix, anti-stripping agents preferably represent from 0.05 to 1% by weight relative to the weight of the hydrocarbon binder. For example, an amount of 0.05 to 0.5% by weight of anti-stripping agents can be added, preferably from 0.1 to 0.3% by weight.

Additives for lowering temperatures of production, application and/or compacting of the bituminous bituminous mix can be, for example, derivatives of Tall Oil, alone or in a mixture with a monoester of a fatty acid mixture, such as those described in document WO 2010/134024.

As suitable additives for the bituminous mix of the invention, mention can also be made of the additives described in document WO 2012/049579 and document WO 2014/095995.

When the aforementioned additives meet the definition of the term “aggregate” given above, and in particular are included in one of the aggregate categories defined above (coarse, medium or fine aggregates or fines), they are counted as aggregates in this category for the purpose of calculating the proportions of the different compounds of the bituminous mix, and not as additives.

### Bituminous Mix Composition

Advantageously, in the bituminous mix of the invention the weight ratio of the petroleum coke to the hydrocarbon binder is 1.8 or higher, more preferably 2 or higher, further preferably 3 or higher. For example, the weight ratio of the petroleum coke to the hydrocarbon binder can be higher than or equal to 1.9, higher than or equal to 2.2, or higher than or equal to 2.5, or higher than or equal to 2.8, or higher than or equal to 3.5, or higher than or equal to 4, or higher than or equal to 4.5, or higher than or equal to 5.

In some embodiments, the bituminous mix may comprise:
from 8 to 45% by weight, preferably 10 to 30% by weight, of petroleum coke;
from 10 to 65% by weight, preferably 15 to 50% by weight, of coarse aggregates having a particle size of 6.3 mm or greater;
from 10 to 65% by weight, preferably from 12 to 40% by weight, of medium aggregates having a particle size greater than 2mm and less than 6.3 mm;
from 5 to 65% by weight, preferably 10 to 50% by weight, of fine aggregates having a particle size of 63 μm to 2 mm;
from 0 to 10% by weight, preferably 0 to 5% by weight, of fines having a particle size of less than 63 μm;
from 2 to 20% by weight, preferably 2 to 10% by weight, of hydrocarbon binder; and
from 0 to 20% by weight of additives:

In some embodiments, the bituminous mix may comprise:
from 8 to 40% by weight, preferably 10 to 30% by weight, of petroleum coke;
from 5 to 55% by weight, preferably 10 to 40% by weight, of coarse aggregates having a particle size of 6.3 mm or greater;
from 5 to 55% by weight, preferably 10 to 40% by weight, of medium aggregates having a particle size greater than 2 mm and less than 6.3 mm;
from 5 to 50% by weight, preferably 10 to 40% by weight, of fine aggregates having a particle size of 63 μm to 2 mm;
from 5 to 40% by weight, preferably 8 to 35% by weight, of fines having a particle size less than 63 μm;
from 2 to 20% by weight, preferably 5 to 15% by weight of hydrocarbon binder; and
from 0 to 20% by weight of additives.

In some embodiments, the bituminous mix essentially consists of, or consists of, the above-described compounds, in any of the above-described configurations of composition.

The bituminous mix of the invention can be recycled, one or more times, for example as aggregates. Therefore, the bituminous mix can be ground and/or crushed to obtain fragments of smaller size. These fragments can then be screened for selection according to their size. For example, they can be reused as coarse aggregates, medium aggregates, fine aggregates and/or fines.

### Preparation of the Bituminous Mix

In another aspect, the invention relates to a method for preparing a bituminous mix such as described above. This method comprises mixing of the components of the bituminous mix, and in particular of the petroleum coke, aggregates and hydrocarbon binder. Preferably, mixing is conducted at a temperature ranging from 100 to 220° C., more preferably from 120 to 200° C.

Mixing of the components can take place for example in a mixer or mixing drum. It can last a time of a few seconds to several hours.

Mixing of the components of the bituminous mix, and in particular of the petroleum coke, aggregates and hydrocarbon binder, can be carried out in one or more steps. Preferably, the petroleum coke is mixed with the aggregates i.e. it is mixed for example with the coarse aggregates, medium aggregates, fine aggregates and/or fines, and/or with the hydrocarbon binder, and/or with the additives (for example colouring agents, anti-caking compounds, reinforcing fibres, emulsifying agents and/or other additives). The above components can be added to the mixture in any order, or all at the same time, or part thereof at the same time. Some of these components can be premixed before being mixed with the other components.

The compounds which are mixed to prepare the bituminous mix are such as described above regarding their nature, particle size and amount.

The petroleum coke is preferably ground before being mixed with the other components.

The method may comprise a step of heating the aggregates and/or the petroleum coke, prior to mixing. They can be heated to a temperature of 100 to 220° C., preferably 120 to 200° C., in an oven for example. The aggregates and/or petroleum coke can be heated for a time of several hours, for example from 3 to 24 h, preferably from 5 to 20 h.

The hydrocarbon binder can be incorporated in the mixture in the form of an emulsion of hydrocarbon binder in water. Emulsions of hydrocarbon binder are well known to the person skilled in the art. Preferably, the emulsion comprises from 50 to 80%, preferably 60 to 80%, by weight of hydrocarbon binder; from 20 to 50%, preferably from 20 to 40%, by weight of water; and optionally one or more emulsifying agents, preferably in an amount of less than 1% by weight, for example from 0.01 to 1% by weight. The viscosity of the emulsion preferably ranges from 20 to 200 s (corresponding to the flow time through a 4 mm orifice at 40° C. measured in accordance with standard NF EN 12846-1).

The emulsion can be prepared just before mixing with the other components or further upstream of mixing. The first case is advantageous since it is then not necessary to obtain an emulsion having extensive stability, making it possible to reduce the quantity of emulsifying agents used and even to omit these completely.

Preferably, when the hydrocarbon binder is incorporated in the mixture in emulsion form, the emulsion is added at ambient temperature (i.e. at a temperature of 15 to 30° C.) or alternatively the emulsion is previously heated to a temperature up to 90° C. The adding of the hydrocarbon binder in the form of an emulsion can allow to facilitate binding of the binder, in particular with the petroleum coke. In addition, the use of an emulsion of hydrocarbon binder can avoid having to heat the binder before it is mixed with the other components.

When a hydrocarbon binder is added to the mixture in the form of an emulsion, it is preferably incorporated after the other components at the end of the mixing step.

The hydrocarbon binder can also be incorporated in the mixture in pure, liquid form. In this case, it is advantageously previously heated to a temperature ranging from 50 to 100° C., or alternatively to a temperature ranging from 100 to 220° C. preferably from 120 to 200° C.

Further alternatively, the hydrocarbon binder can be added in solid, divided form, such as for example in the form of binder granules or binder blocks. By “binder block” it is meant a block of binder weighing between 0.5 g and 1000 kg, preferably between 1 kg and 200 kg, more preferably between 1 kg and 50 kg, further preferably between 5 kg and 25 kg, still further preferably between 10 kg and 30 kg, said block advantageously being parallelepipedal, preferably a slab. “Binder granules” can be defined as a binder that is solid at ambient temperature, packaged in divided form, in the form of units of small size called granules or particles.

Preferably, the binder granules or binder blocks are cold when added to the mixture i.e. at ambient temperature for example. In this variant, the method has the advantage that it can be implemented without a prior heating step of the granules of solid binder and/or blocks of solid binder. Indeed, for example, when the aggregates and/or the petroleum coke have been heated prior to mixing with the hydrocarbon binder, the latter can be added to the mixture without having been previously melted since the solid binder at ambient temperature melts when in contact with the hot aggregates and/or petroleum coke.

Advantageously, the method does not require a heating step of the hydrocarbon binder before it is mixed with the other components of the bituminous mix. More preferably, the temperature of the mixing step is supplied by the heating of the aggregates and/or petroleum coke such as described above, prior to mixing thereof with the hydrocarbon binder.

### Applications

In another aspect, the invention relates to the use of a bituminous mix as described above, in the road industry, to form base courses, binder courses and/or sub-base layers of roadways.

The bituminous mix as described above can also be used for ground surfacing, in particular of roads. As surfaces able to be laid with the bituminous mix of the invention, mention can be made of roadways, surfaces of parking lots; footpaths such as sidewalks or terraces; urban landscaping such as skateparks; flooring of sports equipment or industrial sites; flooring of cold storage rooms.

The bituminous mix such as described above can also be used in various industrial applications, in particular to prepare a waterproof coating, a membrane or impregnating layer. The bituminous mix as described above can be particularly adapted for the manufacture of waterproofing membranes, noise-cancelling membranes, insulating membranes, surfacing, carpet tiles, impregnating layers.

### EXAMPLES

The following examples give a nonlimiting illustration of the invention.

Two compositions are prepared by mixing the following components in the indicated weight amounts:

| Composition | Reference | Composition 1 |
|---|---|---|
| Rolled sand of 0/4 particle size | 19.3% | 19.3% |
| (Eiffage) | | |
| Aggregates of 2/4 particle size | 22.9% | 22.9% |
| (La Noubleau) | | |
| Aggregates of 4/6 particle size | 22.9% | 22.9% |
| (La Noubleau) | | |
| Limestone filler (Piketty) | 26.6% | — |
| Micronized petroleum coke | — | 26.6% |
| Azalt 35/50 Bitumen (FZN) | 8.30% | 8.30% |

In the above composition 1, the petroleum coke is in the form of fines (or fillers).

To prepare the compositions, the materials are heated to 190° C. and then mixed.

Each of the 2 compositions is placed in a metal box (identical box for each composition). A temperature measuring probe is positioned in the centre of each box.

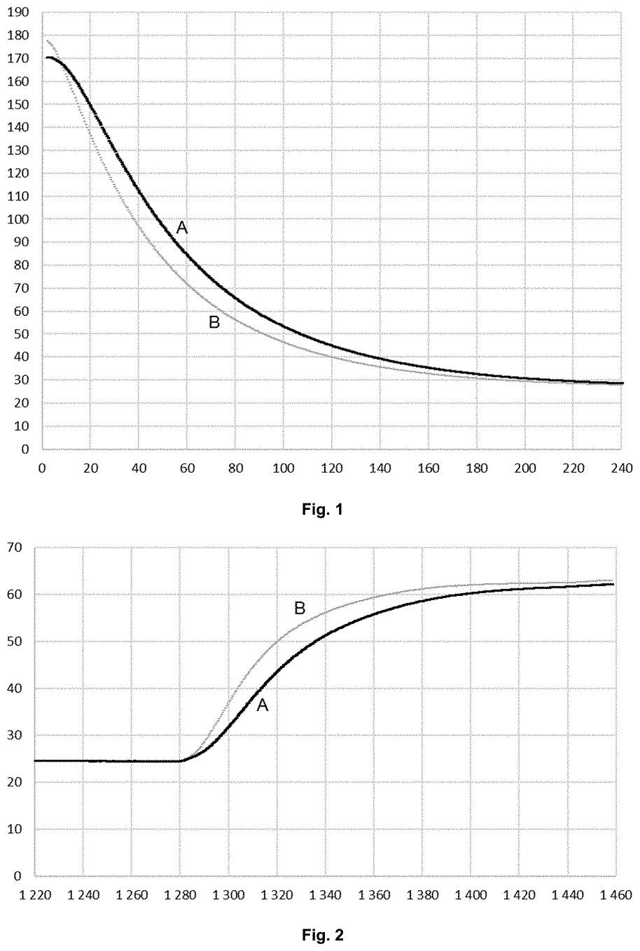

The boxes containing the compositions are left to cool and then placed in an oven at 60° C. to be reheated. The cooling and heating kinetics are measured by means of the probe. The results are given in FIGS. 1 and 2.

On observing the cooling kinetics (FIG. 1) it is ascertained that composition 1 (comprising petroleum coke) reaches the temperature of 30° C. after 208 min, whereas the reference composition (in which petroleum coke was substituted by limestone filler) reaches the temperature of 30° C. after 188.5 min. Composition 1 therefore takes about 20 minutes more to cool down to the temperature of 30° C. than the reference composition. In addition, on observing the heating kinetics (FIG. 2), it is ascertained that the reference composition reaches the temperature of 60° C. at minute 1366.5, whereas composition 1 reaches the temperature of 60° C. at minute 1396.5. Composition 1 therefore takes 30 minutes more to reach the temperature of 60° C. compared with the reference composition.

Composition 1 therefore exhibits better thermal insulation properties than the reference composition.

1.-16. (canceled)

17. A bituminous mix comprising:
at least 50% by weight of aggregates,
at least 8% by weight of petroleum coke, and
at least one hydrocarbon binder.

18. The bituminous mix according to claim 17, wherein the weight ratio of the petroleum coke to the hydrocarbon binder is 1.8 or higher.

19. The bituminous mix according to claim 17, comprising from 8 to 45% by weight of petroleum coke.

20. The bituminous mix according to claim 17, wherein the petroleum coke has a maximum particle size of 20 mm or less.

21. The bituminous mix according to claim 17, wherein the petroleum coke has a maximum particle size of less than 63 μm.

22. The bituminous mix according to claim 17, wherein the aggregates are selected from the group consisting of coarse aggregates having a particle size of 6.3 mm or greater, medium aggregates having a particle size greater than 2 mm and less than 6.3 mm, fine aggregates having a particle size of 63 μm to 2 mm, fines having a particle size of less than 63 μm, and combinations thereof.

23. The bituminous mix according to claim 17, comprising from 50 to 90% by weight of aggregates.

24. The bituminous mix according to claim 17, comprising as aggregates:
from 0 to 90% by weight of coarse aggregates having a particle size of 6.3 mm or greater;
from 0 to 90% by weight of medium aggregates having a particle size greater than 2 mm and less than 6.3 mm;
from 0 to 70% by weight of fine aggregates having a particle size of 63 μm to 2 mm; and
from 0 to 40% by weight of fines having a particle size of less than 63 μm;
relative to the total weight of the coated material.

25. The bituminous mix according to claim 17, comprising from 2 to 20% by weight of hydrocarbon binder.

26. The bituminous mix according to claim 17, wherein the hydrocarbon binder is selected from the group consisting of bitumens, pitch, light-coloured binders and mixtures thereof.

27. The bituminous mix according to claim 17, further comprising from 0 to 20% by weight of additives selected from the group consisting of colouring agents, anti-caking compounds, emulsifying agents, reinforcing fibres, anti-stripping agents, additives for lowering temperatures of production, application and/or compacting of the bituminous mix, and mixtures thereof.

28. The bituminous mix according to claim 17, comprising:
from 8 to 45% by weight of petroleum coke;
from 10 to 65% by weight of coarse aggregates having a particle size of 6.3 mm or greater;
from 10 to 65% by weight of medium aggregates having a particle size greater than 2 mm and less than 6.3 mm;
from 5 to 65% by weight of fine aggregates having a particle size of 63 μm to 2 mm;
from 0 to 10% by weight of fines having a particle size of less than 63 μm;
from 2 to 20% by weight of hydrocarbon binder; and
from 0 to 20% by weight of additives.

29. The bituminous mix according to claim 17, comprising:
from 8 to 40% by weight of petroleum coke;
from 5 to 55% by weight of coarse aggregates having a particle size of 6.3 mm or greater;
from 5 to 55% by weight of medium aggregates having a particle size greater than 2 mm and less than 6.3 mm;
from 5 to 50% by weight of fine aggregates having a particle size of 63 μm to 2 mm;
from 5 to 40% by weight of fines having a particle size of less than 63 μm;
from 2 to 20% by weight of hydrocarbon binder; and
from 0 to 20% by weight of additives.

30. The bituminous mix according to claim 17, wherein the weight ratio of the petroleum coke to the hydrocarbon binder is 2 or higher.

31. The bituminous mix according to claim 17, comprising from 10 to 30% by weight of petroleum coke.

32. The bituminous mix according to claim 17, comprising from 60 to 85% by weight of aggregates.

33. The bituminous mix according to claim 17, comprising as aggregates:
from 5 to 65% by weight of coarse aggregates having a particle size of 6.3 mm or greater;
from 5 to 65% by weight of medium aggregates having a particle size greater than 2 mm and less than 6.3 mm;
from 5 to 65% by weight of fine aggregates having a particle size of 63 μm to 2 mm; and
from 0 to 20% by weight of fines having a particle size of less than 63 μm;
relative to the total weight of the coated material.

34. The bituminous mix according to claim 17, comprising from 5 to 15% by weight of hydrocarbon binder.

35. A method for preparing a bituminous mix according to claim 17, the method comprising:
providing the aggregates, the petroleum coke, and the at least one hydrocarbon binder; and
mixing the aggregates, the petroleum coke, and the at least one hydrocarbon binder,
wherein the mixing is performed at a mixing temperature ranging from 100 to 220° C.

36. The method according to claim 35, wherein the mixing temperature is attained by heating the aggregates and/or the petroleum coke to a temperature of 100 to 220° C. before the mixing step.
